(19) United States
(12) Patent Application Publication
(10) Pub. No.: US 2019/0034136 A1
(43) Pub. Date: Jan. 31, 2019

(54) TERMINAL APPARATUS, RECORDING MEDIUM ON WHICH PROGRAM IS STORED, AND METHOD OF CONTROLLING TERMINAL APPARATUS

(71) Applicant: SEIKO EPSON CORPORATION, Tokyo (JP)

(72) Inventor: Taisuke KANEKO, Shiojiri (JP)

(21) Appl. No.: 16/049,650

(22) Filed: Jul. 30, 2018

(30) Foreign Application Priority Data
Jul. 31, 2017 (JP) 2017-147399

(51) Int. Cl. G06F 3/12

(52) U.S. Cl. CPC G06F 3/1236; G06F 3/1294; G06F 3/1288; G06F 3/1203

(57) ABSTRACT

Provided is a terminal apparatus including a mobile communication unit that communicates with a server apparatus that controls a printer, a beacon reception unit that receives a beacon signal which is dispatched from the printer, and a control unit that acquires a mail address which is included in the beacon signal that is received by the beacon reception unit, and causes a processing request, which includes the acquired mail address, to be transmitted to the server apparatus.

### BACKGROUND

### 1. Technical Field

The present invention relates to a terminal apparatus, a recording medium on which a program is recorded, and a method of controlling the terminal apparatus.

### 2. Related Art

In the related art, a system is known in which a processing request is transmitted to a server apparatus that controls a device and in which the server apparatus causes the device to perform processing that corresponds to the processing request (for example, refer to JP-A-2014-49004).

JP-A-2014-49004 discloses a server apparatus that manages a printing apparatus that is a control target, and a mail address that is set for the printing apparatus, in a state of being associated with each other, and a printing control apparatus that performs log-in processing by being assigned the mail address and transmitting the received mail address to the server apparatus. The printing control apparatus that is disclosed in JP-A-2014-49004 transmits printing job data to the server apparatus when performing the log-in processing. The server apparatus converts the received printing job data into data that is possibly printed by the printing apparatus, transmits the resulting data to the printing apparatus that corresponds to the mail address, and causes the printing to be performed.

However, in JP-A-2014-49004, in order to designate the printing apparatus, the mail address of the printing apparatus has to be input, and thus, there is a need to select a device in a simpler manner and cause the processing to be performed.

### SUMMARY

An advantage of some aspects of the invention is to simply use a device via a server apparatus.

According to an aspect of the invention, there is a terminal apparatus including a communication unit that communicates with a server apparatus which controls a device; a reception unit that receives a beacon signal which is dispatched from the device and includes identification information on the device; and a control unit that acquires the identification information on the device from the beacon signal which is received by the reception unit, and causes a processing request that includes the acquired identification information to be transmitted to the server apparatus.

In this case, the reception unit of the terminal apparatus receives the beacon signal, and thus the identification information on the device can be acquired and the processing request including the acquired identification information is transmitted from the terminal apparatus to the server apparatus. Therefore, the device is easy to use from the terminal apparatus via the server apparatus.

In the terminal apparatus, in a case where the beacon signals that are dispatched from a plurality of the devices are received by the reception unit, the control unit may select the device that is requested to perform processing, based on the received beacon signal, and causes the processing request that includes the identification information on the selected device to be transmitted to the server apparatus.

In this case, the device that is requested to perform the processing can be selected based on the beacon signal.

In the terminal apparatus, the control unit may select the beacon signal based on a reception strength of the beacon signal that is received by the reception unit, and may cause the processing request, which includes the identification information that is acquired from the selected beacon signal, to be transmitted to the server apparatus.

In this case, based on the reception strength of the received beacon signal, the device that is requested to perform the processing is selected. Therefore, in a case where the device that has a great reception strength of the beacon signal is selected, the device that is positioned at a short distance from the terminal apparatus can be requested to perform the processing.

In terminal apparatus, the control unit may acquire status information indicating a processing situation of the device, from the beacon signal that is received by the reception unit, may select the device that is requested to perform the processing, based on the acquired status information, and may cause the processing request including the identification information on the selected device, to be transmitted to the server apparatus.

In this case, based on the status information that is included in the beacon signal, the device that is requested to perform the processing can be selected. Therefore, the processing request can be set to be made to the device that is not requested to perform the processing, or the processing request can be set not to be made to the device that takes time to complete the processing.

In the terminal apparatus, the control unit may transmit the identification information, which is required from the beacon signal, to the server apparatus, may receive device information indicating a processing capability of the device that corresponds to the identification information, from the server apparatus, may select the device that is requested to perform the processing, based on the received device information, and may cause the processing request, which includes the identification information on the selected device, to be transmitted to the server apparatus.

In this case, based on the device information that is received from the server apparatus, the device that is requested to perform the processing can be selected. Therefore, the processing request can be made to the device that possibly performs the processing request.

In the terminal apparatus, a reporting unit may be further included, and the control unit may receive the beacon signal that is dispatched from the selected device and may cause the reporting unit to make a report based on a change in a reception strength of the received beacon signal.

In this case, because the report is made based on the change in the reception strength of the received beacon signal, a direction of the selected device can be reported. For example, the report is made in a case where the reception strength of the beacon signal decreases. Thus, the report can be made in a case where the terminal apparatus moves in the opposite direction to the device that is requested to perform the processing. Furthermore, the report is made in a case where the reception strength of the beacon signal increases. Thus, the report can be made in a case where the terminal apparatus moves in the direction of approaching the device that is requested to perform the processing.

In the terminal apparatus, a display unit and an operation unit may be further included, and the control unit may transmit the identification information, which is received from the beacon signal, to the server apparatus, may receive device information on the device that corresponds to the identification information, from the server apparatus, may cause the received device information to be displayed on the display unit, and may cause the processing request, which includes the identification information on the device that corresponds to the device information that is selected by an operation that is performed in the operation unit, to be transmitted to the server apparatus.

In this case, the device information on the device that is a transmission source of the received beacon signal is caused to be displayed on the display unit, and the processing request to the selected device can be transmitted to the server apparatus.

In the terminal apparatus, the control unit may obtain proximity to the device based on a reception strength of the beacon signal that is received by the reception unit, and may cause the obtained proximity to be displayed on the display unit in a state of being associated with the device information.

In this case, the reception strength of the beacon signal and the device information are displayed on the display unit in a state of being associated with each other. Therefore, based on the reception strength of the beacon signal and the device information, the device that causes the processing to be performed is caused to be selected by a user.

In the terminal apparatus, the control unit may cause the device information to be displayed in order of decreasing the reception strength of the beacon signal.

In this case, because the device information is displayed in order of decreasing the reception strength of the beacon signal, the device information is displayed in order of increasing a distance to the device. Therefore, the device that is requested to perform the processing is easy to select.

In the terminal apparatus, the reporting unit may be further included, and the control unit may receive the beacon signal that is dispatched from the device which corresponds to device information that is selected by an operation that is performed in the operation unit, and may cause the reporting unit to make a report based on a change in the reception strength of the received beacon signal.

In this case, because the report is made based on the change in the reception strength of the received beacon signal, the direction of the selected device can be reported. For example, the report is made in the case where the reception strength of the beacon signal decreases. Thus, the report can be made in the case where the terminal apparatus moves in the opposite direction to the device that is requested to perform the processing. Furthermore, the report is made in a case where the reception strength of the beacon signal increases. Thus, the report can be made in the case where the terminal apparatus moves in the direction of approaching the device that is requested to perform the processing.

In the terminal apparatus, the identification information may be a mail address that is assigned to the device.

In this case, the mail address can be used for the identification information on the device.

According to another aspect of the prevention, there is provided a printing system including a server apparatus that stores identification information on a device that is a control target, and causes the device to perform the processing; and a terminal apparatus that is connected to the server apparatus in a manner that possibly communicates with the server apparatus and transmits a processing request to the device is transmitted to the server apparatus, in which the terminal apparatus a reception unit that receives a beacon signal which is dispatched from the device and includes the identification information on the device; and a control unit that acquires the identification information on the device from the beacon signal which is received by the reception unit, and causes a processing request that includes the acquired identification information to be transmitted to the server apparatus.

In this case, the reception unit of the terminal apparatus receives the beacon signal, and thus the identification information on the device can be acquired and the processing request including the acquired identification information is transmitted from the terminal apparatus to the server apparatus. Therefore, the device is easy to use from the terminal apparatus via the server apparatus.

In the printing system, the server apparatus may cause the device, which corresponds to the identification information which is included in the received processing request, to perform processing that corresponds to the processing request.

In this case, the device is caused to perform the processing that corresponds to the identification information.

According to still another aspect of the invention, there is provided a computer-readable recording medium on which a program, which is caused to be executed by a computer that is built into a terminal apparatus which includes a communication unit that communicates with a server apparatus that controls a device and a reception unit that receives a beacon signal which is dispatched from the device, is stored, the program causing the computer to execute: a procedure for acquiring identification information on the device, which is included in the beacon signal that is received by the reception unit; and a procedure for causing the communication unit to transmit a processing request, which is included in the acquired identification information, to the server apparatus.

In this case, the reception unit of the terminal apparatus receives the beacon signal, and thus the identification information on the device can be acquired and the processing request including the acquired identification information is transmitted from the terminal apparatus to the server apparatus. Therefore, the device is easy to use from the terminal apparatus via the server apparatus.

According to still another aspect of the invention, there is a method of controlling a terminal apparatus that includes a communication unit which communicates with a server apparatus that controls a device and a reception unit which receives a beacon signal which is dispatched from the device, the method including: acquiring identification information on the device, which is included the beacon signal that is received by the reception unit; and causing the communication unit to transmit a processing request, which is included in the acquired identification information, to the server apparatus.

In this case, the reception unit of the terminal apparatus receives the beacon signal, and thus the identification information on the device can be acquired and the processing request including the acquired identification information is transmitted from the terminal apparatus to the server apparatus. Therefore, the device is easy to use from the terminal apparatus via the server apparatus.

### BRIEF DESCRIPTION OF THE DRAWINGS

The invention will be described with reference to the accompanying drawings, wherein like numbers reference like elements.

FIG. 1 is a systematic configurational diagram of a printing system.

FIG. 2 is a configurational diagram of a terminal apparatus.

FIG. 3 is a configurational diagram of a server apparatus.

FIG. 4 is a diagram illustrating a configuration of a device management table.

FIG. 5 is a configurational diagram of a printer.

FIG. 6 is a flowchart illustrating operation of the terminal apparatus.

FIG. 7 is a flowchart illustrating operation of the server apparatus.

FIG. 8 is a diagram illustrating an example of a printer list.

FIG. 9 is a flowchart illustrating the operation of the terminal apparatus.

### DESCRIPTION OF EXEMPLARY EMBODIMENTS

### First Embodiment

Embodiments of the invention will be described below with reference to the drawings.

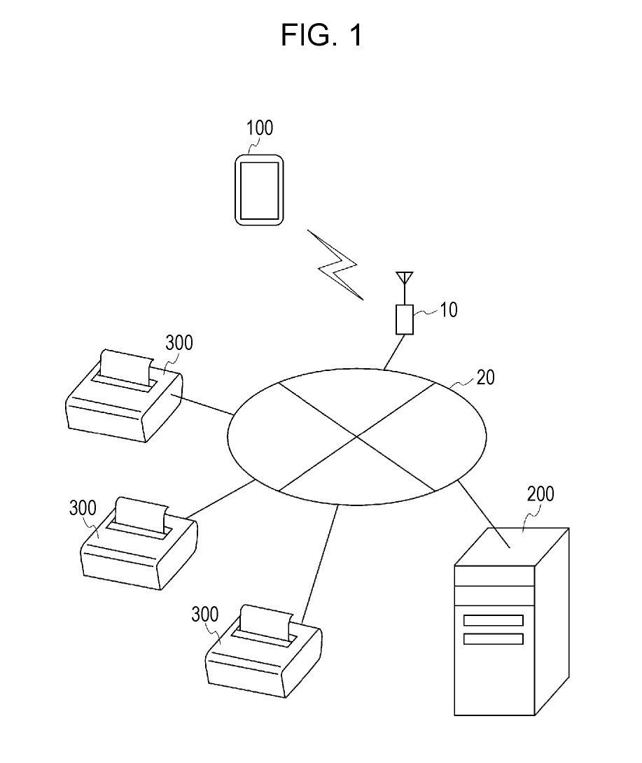

FIG. 1 is a systematic configurational diagram of a printing system 1.

A printing system 1 includes a terminal apparatus 100, a server apparatus 200, and a plurality of printers 300. The printer 300 is equivalent to a “device” according to an aspect of the invention. The printing system 1 is equivalent to a “processing system” according to an aspect of the invention.

In the present embodiment, a case where a smartphone (a multifunctional portable telephone) is used as the terminal apparatus 100 is described, but the terminal apparatus 100 is not limited to the smartphone. For example, other portable information communication equipment, such as a personal computer (PC) or a personal digital assistant (PDA) as the terminal apparatus 100, or a notebook PC may be used. Furthermore, three printers 300 are illustrated in FIG. 1, but the number of printers 300 is not limited to 3, and may be 1, 2, or 4 or more.

The terminal apparatus 100 is connected to a network 20 through a base station 10. The network 20, for example, is set up as the Internet, a local area network (LAN), a wide area network (WAN), a dedicated communication line, a mobile communication network (including a base station and the like), a gateway, or the like. The server apparatus 200 or a plurality of printers 300 are connected to the network 20. The base station 10, for example, relays wireless communication by the terminal apparatus 100, based on the known mobile communication standards, such as 4th generation (4G) and Long Term Evolution (LTE).

The server apparatus 200 is an apparatus that controls a plurality of printers 300, and stores printer information on a control-target printer 300. The printer information is equivalent to “device information” according to the aspect of the invention. For example, capability information indicating a model name of the printer 300 or processing that is possibly performed by the printer 300 is included in the printer information. For example, information on a printing mode that is supportable, information on a paper sheet cassette that is mountable, information on a paper sheet size that is available for printing, and the like are included in the capability information. Furthermore, for example, a both-sides printing mode in which printing is performed on both sides of a paper sheet, a color printing mode in which color printing is performed, and the like are included in the printing mode.

The server apparatus 200 processes a request from the terminal apparatus 100, and causes the control-target printer 300 to perform processing.

A plurality of printers 300 are processing apparatus that perform processing under the control of the server apparatus 200.

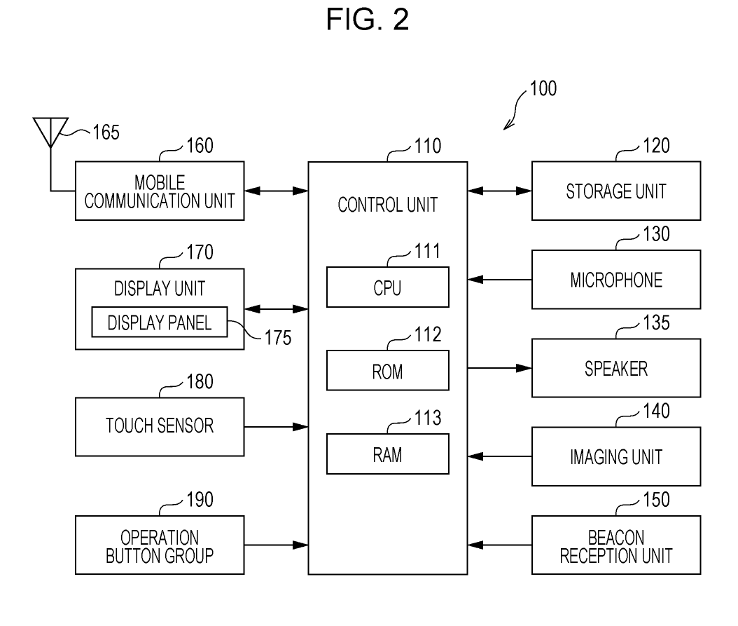

FIG. 2 is a configurational diagram of the terminal apparatus 100.

The terminal apparatus 100 includes a control unit 110, a storage unit 120, a microphone 130, a speaker 135, an imaging unit 140, a beacon reception unit 150, a mobile communication unit 160, a display unit 170, a touch sensor 180, and an operation button group 190. The beacon reception unit 150 is equivalent to a “reception unit” according to the aspect of the invention. Furthermore, the mobile communication unit 160 is equivalent to a “communication unit” according to the aspect of the invention.

The control unit 110 includes a central processing unit (CPU) 111 or a read only memory (ROM) 112, a random access memory (RAM) 113, and the like, and controls operation of the terminal apparatus 100 in a centralized manner. The control unit 110 is equivalent to a computer that performs processing by executing a program according to the aspect of the invention.

The CPU 111 is a processor that performs arithmetic-operation processing, and performs the arithmetic-operation processing according to a control program that is stored in the ROM 112 or the storage unit 120. For example, a control program or an arithmetic-operation data is stored in the ROM 112, which is a nonvolatile memory. The RAM 113 is used as a working area in which the control program or the arithmetic-operation data that is performed or used, respectively, by a processor is temporarily stored.

A configuration in which a function of the control unit 110 is realized by one processor is illustrated in FIG. 2, but the function of the control unit 110 may be realized by a plurality of processors or a semiconductor chip. For example, the control unit 110 may be configured to further include a co-processor, such as a system-on-a-chip (SoC) or a micro control unit (MCU), or a field-programmable gate array (FPGA). Furthermore, the control unit 110 causes both the CPU 111 and the co-processor to cooperate with each other, but, alternatively, may perform various types of control by selectively using one of the CPU 111 and the co-processor.

The storage unit 120 is an internal storage, and for example, is configured with a nonvolatile memory such as a flash memory. An application program that is executed by the control unit 110, capture image data (moving image data or still image data) that is captured by the imaging unit 140, and the like are stored in the storage unit 120.

Audio from the outside is input into the microphone 130. The audio that is input is converted by an audio processing unit (not illustrated) into an audio signal, and the resulting audio signal is output to the control unit 110.

Furthermore, the speaker 135 outputs audio to the outside. The audio processing unit converts an audio signal, which is input from the control unit 110, into audio and outputs the resulting audio from the speaker 135. The speaker 135 is equivalent to a “reporting unit” according to the aspect of the invention.

The imaging unit 140 includes an imaging lens and an imaging element (whose illustrations are both omitted), image-captures a photographic subject under the control of the control unit 110, and generates a still image or a moving image.

When the terminal apparatus 100 stays within a communication range of a beacon signal that is dispatched from the printer 300, the beacon reception unit 150 receives the beacon signal in compliance with Bluetooth Low Energy (BLE: a registered trademark), which is broadcast from the printer 300. The beacon reception unit 150 outputs a notification that the beacon signal is received, to the control unit 110, and extracts information that is superimposed on the received beacon signal. The beacon reception unit 150 outputs the extracted information to the control unit 110. In addition to a universally unique identifier (UUID) that is used for identification of the beacon signal, a mail address or status information on the printer 300 is included in the received beacon signal. The mail address is identification information that possibly identifies the printer 300. Furthermore, the status information is information indicating a processing situation of the printer 300 that dispatches the beacon signal. For example, pieces of status information include situations such as being busy, being idle, being unavailable.

Furthermore, the beacon reception unit 150 calculates a reception strength of the received beacon signal. For example, the beacon reception unit 150 calculates a received signal strength indicator (RSSI) value that appears when the beacon signal is received, as an indicator value indicating the reception strength of the beacon signal. The beacon reception unit 150 outputs the calculated reception strength to the control unit 110.

The mobile communication unit 160 includes an antenna 165, and receives a signal that is transmitted from other communication equipment, or a signal that is transmitted from the server apparatus 200 that is connected to the network 20, through the base station 10. The mobile communication unit 160 performs reception processing operations, such as down-converting and A/D conversion, on the received signal, and outputs the resulting signal to the control unit 110.

Furthermore, the mobile communication unit 160 performs transmission processing operations, such as D/A conversion, amplification, up-converting, on a signal that is generated by the control unit 110, and wirelessly transmits the processed signal from the antenna 165. The transmission signal that is transmitted from the antenna 165 is transmitted to other communication equipment through the base station 10.

The display unit 170 includes a display panel 175. For example, a liquid crystal display or an organic electroluminescent (EL) display can be used for the display panel 175. The display unit 170 displays various pieces of information, such as a letter, a symbol, and a diagram, on the display panel 175 under the control of the control unit 110. The display unit 170 is equivalent to the “display unit” and the “reporting unit” according to the aspect of the invention.

The touch sensor 180 is positioned to be on top of the display panel 175, and detects an operation that is performed, by an operating tool such as a finger, on the display panel 175. The display panel 175 and the touch sensor 180 are equivalent to “operation units” according to the aspect of the invention, and constitute a touch panel. When a user performs a touch operation in which a user brings his/her finger into contact with the display panel 175, the touch sensor 180 detects the touch operation, and outputs an operation signal that corresponds to the detected touch operation, to the control unit 110. Positional information indicating a position of the display panel 175, with which the operation tool is brought into contact, is included in the operation signal. The control unit 110 specifies the operation detail of an operation that is performed on the display panel 175, based on the operation signal that is input, and performs processing that corresponds to the specified operation detail.

Various operation buttons, such as a power button for powering on and off the terminal apparatus 100 and a button for performing various settings for the terminal apparatus 100, are provided on the operation button group 190. The operation button group 190 outputs the operation signal that corresponds to the buttons that is operated, to the control unit 110. The operation button group 190 is equivalent to the “operation unit” according to the aspect of the invention.

Pieces of information, such as the notification that the beacon signal is received, the UUID, the mail address, the status information, and the reception strength, are input into the control unit 110. The control unit 110 generates a request for acquisition of the printer information including the mail address, which is input from the beacon reception unit 150. The control unit 110 transmits the generated request for acquisition to the server apparatus 200 through the mobile communication unit 160.

Furthermore, when receiving the printer information from the server apparatus 200, the control unit 110 causes the display unit 170 to display the printer information and the reception strength, which are received, on the display panel 175. At this point, in a case where the beacon reception unit 150 receives beacon signals that are dispatched from a plurality of printers 300, pieces of printer information on the plurality of printers 300 are displayed on the display panel 175. The control unit 110 causes the printer information and the reception strength of the beacon signal, which is received from the printer 300 that corresponds to the printer information, to be displayed on the display panel 175, in a state of being associated with each other. Furthermore, the mode name of and the capability information on the display panel 175 are included in the printer information that are displayed on the printer 300.

Furthermore, when a printer is selected by operating operation button group 190 or performing the touch operation on the display panel 175, the control unit 110 generates a processing request that includes a mail address of the selected printer 300. In addition to the mail address, print-target data, such as image data or text data, a printing setting, and the like are included in the processing request. The control unit 110 transmits the generated processing request to the server apparatus 200.

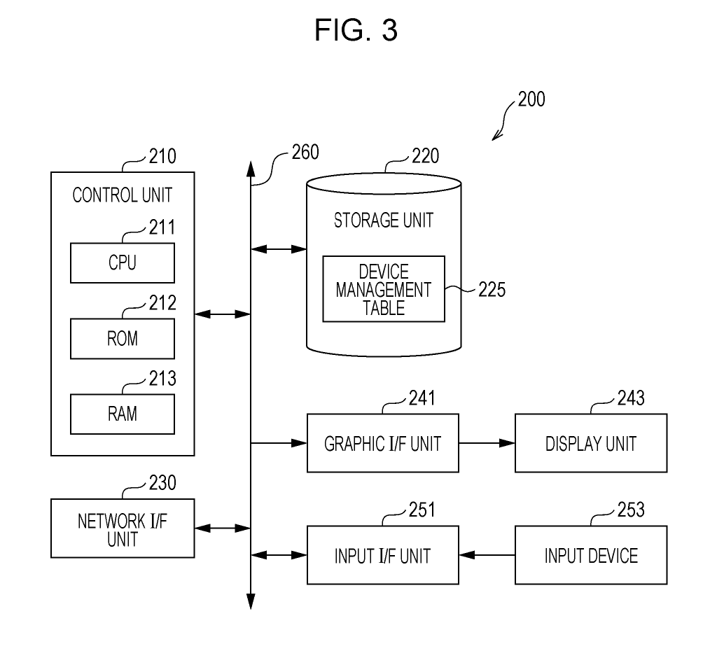

FIG. 3 is a configurational diagram of the server apparatus 200.

The server apparatus 200 includes a control unit 210, a storage unit 220, a network I/F unit 230, a graphic I/F unit 241, a display unit 243, an input I/F unit 251, and an input device 253, and the like. These units are connected to a system bus 260 in a manner that possibly communicates with each other.

The control unit 210 includes a CPU 211 or a ROM 212, a RAM 213, and the like, and controls operation of the server apparatus 200 in a centralized manner.

The CPU 211 is a processor that performs arithmetic-operation processing, and performs the arithmetic-operation processing according to a control program that is stored in the ROM 212 or the storage unit 220. For example, a control program or an arithmetic-operation data is stored in the ROM 212, which is a nonvolatile memory. The RAM 213 is used as a working area in which the control program or the arithmetic-operation data that is performed or used, respectively, by a processor is temporarily stored.

A configuration in which a function of the control unit 210 is realized by one processor is illustrated in FIG. 3, but the function of the control unit 210 may be realized by a plurality of processors or a semiconductor chip. For example, the control unit 210 may be configured to further include a co-processor, such as a system-on-a-chip (SoC) or a micro control unit (MCU), or a field-programmable gate array (FPGA). Furthermore, the control unit 210 causes both the CPU 211 and the co-processor to cooperate with each other, but, alternatively, may perform various types of control by selectively using one of the CPU 211 and the co-processor.

The storage unit 220, for example, is an auxiliary storage device such as a hard disk device.

A device management table 225 is stored in the storage unit 220.

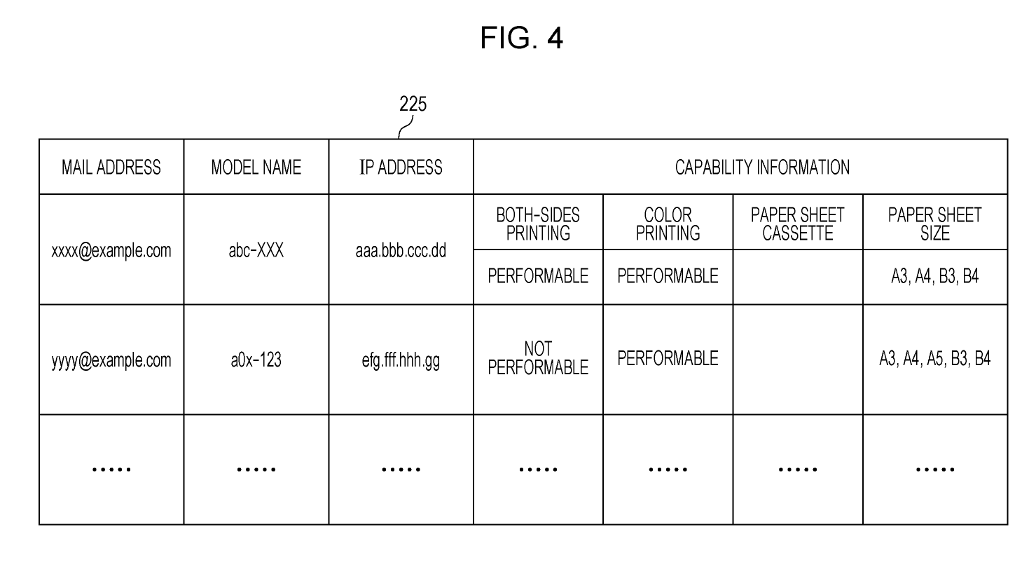

FIG. 4 is a diagram illustrating a configuration of the device management table 225.

The device management table 225 is a table in which the printer information on the control-target printer 300 that is controlled by the server apparatus 200 is registered. In the device management table 225, information on one printer 300 is registered as one record. A model name, a mail address, and an IP address, and capability information are included in one record. The model name is a name of the printer 300. The mail address is identification information that makes it possible to uniquely recognize the printer 300 on a network, and is an address that differs from one printer 300 to another. The IP address is a destination address that is used for transmission of data to the printer 300. The capability information is information indicating processing that is performable by the printer 300. For example, information on whether or not to both-sides printing is performable, information on whether or not color printing is performable, information on a paper sheet cassette that is mountable, information on a paper sheet size that is available for printing, and the like are included in the capability information.

The network I/F unit 230 is an interface through which the server apparatus 200 communicates with equipment other than the printer 300, the terminal apparatus 100, or the like, through the network 20. For example, a network card such as an Ethernet (a registered trademark) card can be used as the network I/F unit 230.

The graphic I/F unit 241 displays various pieces of information, such as a letter, a symbol, and a diagram, on the display unit 243 under the control of the control unit 210. The display unit 243 includes a display panel such as a liquid crystal panel or an organic EL panel, or the like.

When the input device 253, such as a keyboard or a mouse, is operated, the input I/F unit 251 generates an operation signal that corresponds to the operation, and output the generated signal to the control unit 210.

The control unit 210 processes a request that is received from the terminal apparatus 100.

When receiving the request for acquisition of the printer information from the terminal apparatus 100, the control unit 210 extracts the mail address from the acquisition request. Referring to the device management table 225, the control unit 110 acquires the printer information on the printer 300 that corresponds to the extracted mail address. The control unit 210 transmits the acquired printer information to the terminal apparatus 100 from which the acquisition request is received.

Furthermore, when receiving the processing request from the terminal apparatus 100, the control unit 210 acquires a mail address, printing-target data, data on a printing setting, and the like from the received processing request. The control unit 210 converts the printing-target data into image data according to the printing setting. The control unit 210 generates the image data that results from the conversion, and a printing command that includes the printing setting. The control unit 210 transmits the generated printing command to the printer 300 that corresponds to the mail address.

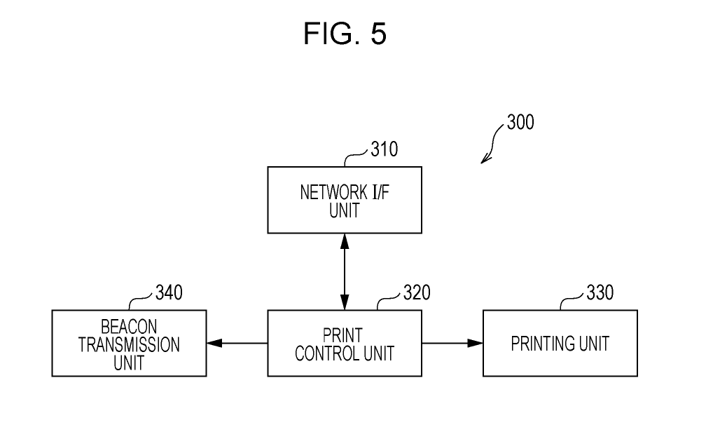

FIG. 5 is a configurational diagram of the printer 300.

The printer 300 includes a network I/F unit 310, a print control unit 320, a printing unit 330, and a beacon transmission unit 340.

The network I/F unit 310 is an interface through which the printer 300 communicates with the server apparatus 200 through the network 20. For example, a network such as an Ethernet card can be used as the network I/F unit 310.

The print control unit 320 includes a CPU, a ROM, a RAM, and the like, (any of which is not illustrated) and controls each unit of the printer 300. Firmware that is a control program for the printer 300 is stored in the ROM. The CPU controls each unit of the printer 300 by executing the firmware that is read from the ROM and is loaded onto the RAM. The RAM is used as a working memory for the CPU to use for arithmetic operation.

The print control unit 320 receives a printing command from the server apparatus 200 through the network I/F unit 310. The print control unit 320 acquires image data or a printing setting from the received printing command, and loads the acquired image data onto the memory such as the RAM. According to the printing setting, the print control unit 320 reads the image data from the memory and outputs the resulting image data to the printing unit 330.

The printing unit 330 includes a print head (whose illustration is omitted), and prints the image data, which is input from the print control unit 320, on a paper sheet.

The beacon transmission unit 340 repeatedly transmits the beacon signal in a broadcast manner, at a fixed transmission time interval, using a short-distance wireless communication scheme, such as BLE. At least a mail address that is identification information on the printer 300 and status information on the printer 300 are included in the beacon signal.

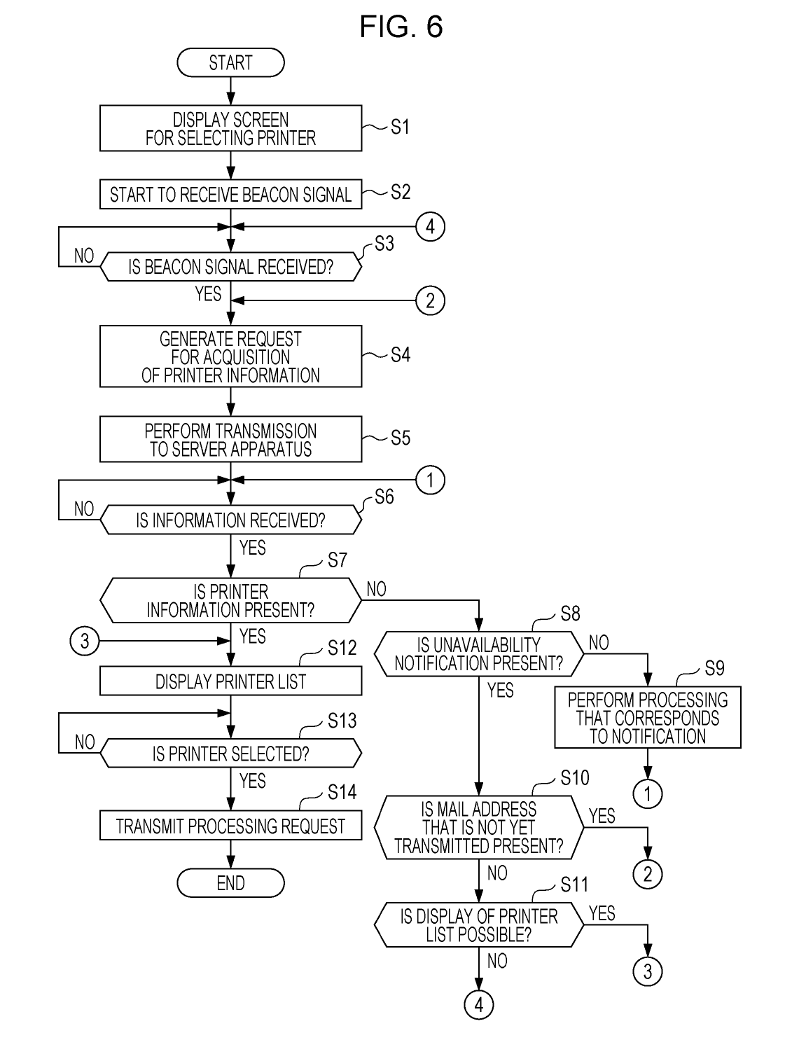

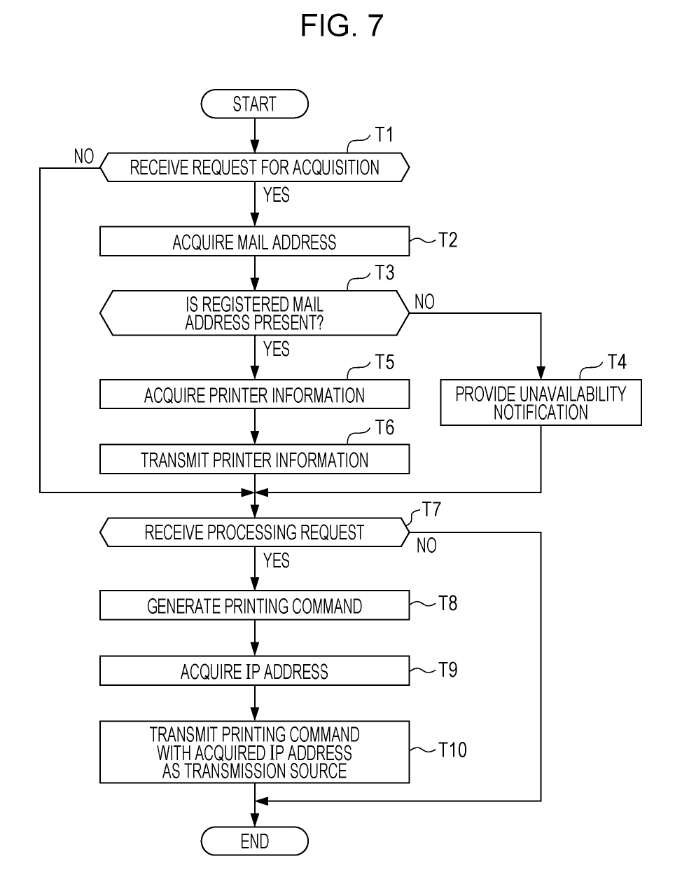

FIG. 6 is a flowchart illustrating operation of the terminal apparatus 100. FIG. 7 is a flowchart illustrating operation of the server apparatus 200.

The operation of each of the terminal apparatus 100 and the server apparatus 200 will be described with reference to the flowcharts that are FIGS. 6 and 7.

A plurality of printers 300 in the printing system 1, for example, are installed within a company or a store, or the like, and repeatedly transmit the beacon signals in a broadcast manner at a fixed transmission time interval.

In a case where the printer 300 is caused to perform printing, a user of the terminal apparatus 100 causes an application program to be activated by performing the touch operation on the display panel 175 or operating the operation button group 190. When an operation of activating the application program is performed, the control unit 110 of the terminal apparatus 100 executes the application program and causes a screen for selecting the printer 300 to be displayed on the display panel 175 (Step S1).

When the screen for selection, the printer 300 is caused to be displayed on the display panel 175, the control unit 110 causes the beacon reception unit 150 to receive the beacon signal (Step S2). At this time, the control unit 110 may cause a message, which notifies that reception of the beacon signal is in progress, to be displayed on the screen for selecting the printer 300.

When the terminal apparatus 100 stays within the communication range of the beacon signal that is dispatched by the printer 300, the beacon reception unit 150 receives the beacon signal that is broadcast from the printer 300. When receiving the beacon signal, the beacon reception unit 150 outputs the notification that the beacon signal is received, to the control unit 110. Furthermore, the beacon reception unit 150 extracts the mail address or the status information, which is superimposed on the received beacon signal, and outputs the result of the extraction to the control unit 110.

Based on the reception notification from the beacon reception unit 150, the control unit 110 determines whether or not the beacon signal is received (Step S3). In a case where the reception notification from the beacon reception unit 150 is not input, the control unit 110 determines that the beacon signal is not received (NO in Step S3), the control unit 110 waits until the reception notification is input. Furthermore, in a case where the beacon reception unit 150 cannot receive the beacon signal, the control unit 110, for example, may cause a message saying “The beacon signal cannot be received. Please move a place where the beacon signal is possibly received” to be displayed on the display panel 175.

In a case where the reception notification is input from the beacon reception unit 150, the control unit 110 determines that the beacon signal is received (YES in Step S3), generates the request for acquisition of the printer information (Step S4). When the request for acquisition is generated, the control unit 110 transmits the generated request for acquisition to the server apparatus 200 (Step S5).

At this point, operation of the server apparatus 200 is described with reference to FIG. 7.

In case where the request for acquisition is received from the terminal apparatus 100 (YES in Step T1), the control unit 210 of the server apparatus 200 acquires the mail address from received the request for acquisition (Step T2). Next, the control unit 210 determines whether or not the acquired mail address is a mail address associated with the printer 300, which is registered in the device management table 225 (Step T3).

In a case where the acquired mail address is not registered in the device management table 225 (NO in Step T3), the control unit 210 notifies the terminal apparatus 100, which is a transmission source of the request for acquisition, that a corresponding printer 300 is not present (Step T4). The notification is hereinafter referred to as an unavailability notification.

Furthermore, in a case where the acquired mail address is registered in the device management table 225 (YES in Step T3), the control unit 210 acquires the printer information on the printer 300, which is associated with the mail address, from the device management table 225 (Step T5). The model name of the printer 300 and the capability information are included in the printer information. When acquiring the printer information, the control unit 210 transmits the acquired printer information to the terminal apparatus 100 that is the transmission source of the request for acquisition (Step T6).

Operation of the terminal apparatus 100 is described with reference back to a flowchart that is illustrated in FIG. 6.

When transmitting the generated request for acquisition to the server apparatus 200 (Step S5), the control unit 110 waits until information is received from the server apparatus 200 (Step S6). In a case where the information is not received from the server apparatus 200 (NO in Step S6), the control unit 110 waits until the information is received.

Furthermore, in a case where the information is received from the server apparatus 200 (YES in Step S6), the control unit 110 determines whether or not the received information is the printer information (Step S7). In a case where the received information is not the printer information (NO in Step S7), the control unit 110 determines whether or not the received information is the unavailability notification (Step S8). In a case where the received information is not the unavailability notification (NO in Step S8), the control unit 110 performs processing associated with the received information (Step S9). Thereafter, the control unit 110 returns to the determination in Step S6, and waits until the information is received from the server apparatus 200 (Step S6).

Furthermore, in a case where the received information is the unavailability notification (YES in Step S8), the control unit 110 determines whether or not a mail address that is not yet transmitted, as the request for acquisition, to the server apparatus 200 is present (Step S10). In a case where the mail address that is not yet transmitted is present (YES in Step S10), the control unit 110 returns to Step S4, generates the request for acquisition of the printer information, and transmits the generates request to the server apparatus 200.

Furthermore, in a case where it is determined that the mail address that is not yet transmitted is not present (NO in Step S10), the control unit 110 determines whether or not display of a printer list is possible (Step S11).

In a case where beacon signals are received from a plurality of printers 300, if the printer information on the printer 300 that corresponds to at least one of the beacon signals is received from the server apparatus 200, the control unit 110 determines that the printer list is displayable.

In a case where it is determined that the display of the printer list is not possible (NO in Step S11), the control unit 110 returns to Step S3, and again receives the beacon signal. Furthermore, when it is determined that the display of the printer list is possible, that the control unit 110 proceeds to processing in Step S12, and causes the printer list to be displayed on the display panel 175.

Furthermore, when it is determined that the information which is received from the server apparatus 200 is the printer information (YES in Step S7), the control unit 110 causes the model number or the capability information, which is included in the received printer information, to be displayed in the printer list (Step S12).

Furthermore, in a case where a plurality of pieces of printer information are caused to be displayed in the printer list, the control unit 110 sorts pieces of printer information for display, based on the reception strength. The control unit 110 sorts pieces of printer information in such a manner that pieces of printer information on the printer 300 which have great reception strengths are displayed.

Furthermore, in a case where the beacon signal is received, but a status of a printer 300 is “unavailable,” the control unit 110 may change a display mode from display of printer information on such a printer 300 to display of printer information on another printer 300. For example, the control unit 110 may display the printer information on the printer 300, which has the status of being “unavailable,” in a gray color, and thus may indicate that such a printer 300 is excluded from an operation target. Furthermore, the printer information is not limited to being displayed in a gray color, and may be displayed in a different color than another available printer 300.

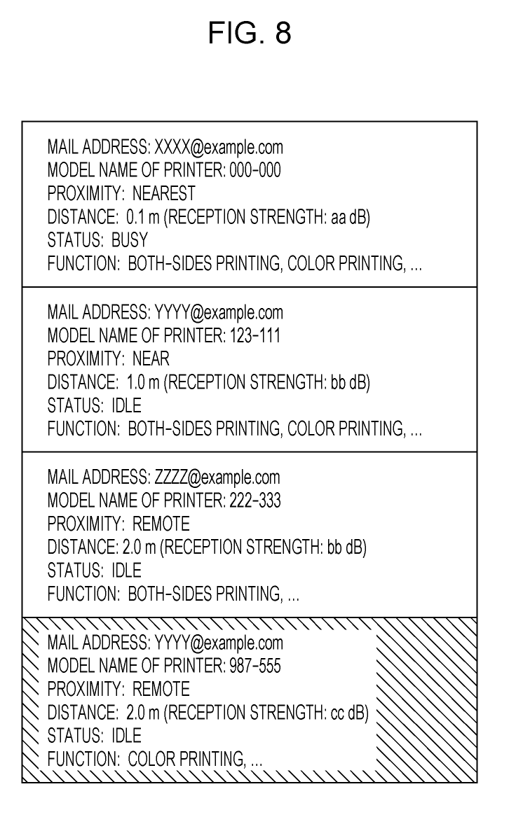

FIG. 8 is a diagram illustrating an example of the printer list.

A mail address, proximity, a distance, and a reception strength are displayed, as information on one printer 300, on the printer list. The mail address is a mail address that is extracted from the beacon signal that is received by the beacon reception unit 150. The proximity is displayed to indicate a distance between the terminal apparatus 100 and the printer 300, and for example, according to the distance between the terminal apparatus 100 and the printer 300, is displayed in three levels, “nearest,” “near,” and “remote.” Furthermore, the distance is one that indicates the distance between the terminal apparatus 100 and the printer 300 as a numerical value, and is calculated based on the reception strength of the beacon signal which is received by the beacon reception unit 150. The reception strength is information indicating the reception strength of the beacon signal that is received by the beacon reception unit 150.

In the printer list that is illustrated in FIG. 8, the greater the reception strength of the beacon signal the printer information on the printer 300 includes, the higher a position of the printer information is in the print list. Furthermore, in the printer list that is illustrated in FIG. 8, the printer 300, the printer information on which is displayed in the uppermost position, is the printer information on the printer 300 that has the status of being “available.” The printer information on the printer 300 that has the status of “unavailable” is displayed in a gray color.

Next, the control unit 110 determines whether or not the printer 300 that is requested to perform printing is selected (Step S13). In a case where an operation of selecting the printer 300 is performed (NO in Step S13), the control unit 110 waits until such an operation is performed.

Furthermore, in a case where a selection of the printer 300 is made, (YES in Step S13), the control unit 110 generates a processing request that includes a mail address of the selected printer 300, and printing-target data, such as image data that is selected by the user or text data. The control unit 110 transmits the generated processing request to the server apparatus 200 (Step S14).

Furthermore, when receiving the selection of the printer 300 that is requested to perform the printing is made, the control unit 110 continues to cause the beacon reception unit 150 to receive the beacon signal that is transmitted from the selected printer 300. Based on a change in the reception strength of the beacon signal that is received by the control unit 110, the beacon reception unit 150 guides the user of the terminal apparatus 100 toward the printer 300 that makes the processing request. Whenever receiving the beacon signal, the beacon reception unit 150 calculates the reception strength of the received beacon signal, and outputs the calculated reception strength to the control unit 110. The control unit 110 obtains a difference between the reception strength that is input from the beacon reception unit 150 and the previous reception strength, and obtains the change in the reception strength. In a case where the reception strength decreases, the control unit 110, for example, causes a message saying “The terminal apparatus moves in the opposite direction to the printer 300” to be displayed on the display panel 175, to make a report. Furthermore, in a case where the reception strength decreases, the control unit 110 may output audio, which is set in advance, from the speaker 135, to make a report.

Furthermore, in a case where the reception strength increases, the control unit 110 may cause a message saying “The terminal apparatus moves toward the direction of the printer 300,” to be displayed on the display panel 175, or may output audio, which is set in advance, from the speaker 135, to make a report.

Operation of the server apparatus 200 that receives the processing request is described with reference to a flowchart that is illustrated in FIG. 7.

The control unit 210 determines whether or not the processing request is received from the terminal apparatus 100 (Step T7). In a case where the processing request is not received (NO in Step T7), the control unit 210 causes this processing flow to be ended. Furthermore, in a case where the processing request is received (YES in Step T7), the control unit 210 acquires a mail address, a printing-target data, and a printing setting that are included in the received processing request. Next, the control unit 210 converts the printing-target data into an image data according to the printing setting and generates the printing command that includes the image data that results from the conversion, or the printing setting (Step T8). Furthermore, the control unit 210 acquires the IP address of the printer 300, the identification information of which is set to be the mail address that is included in the processing request, from the device management table 225 (Step T9). Then, the control unit 210 transmits the generated printing request to a transmission destination of the acquired IP address (Step T10).

The terminal apparatus 100 according to the first embodiment, as described above, includes the mobile communication unit 160, the beacon reception unit 150, and the control unit 110.

The mobile communication unit 160 communicates with the server apparatus 200 that controls the printer 300.

The beacon reception unit 150 receives the beacon signal from that is dispatched from the printer 300.

the control unit 110 acquires the mail address as the identification information on the printer 300, which is included in the beacon signal that is received by the beacon reception unit 150. The control unit 110 transmits the processing request, which includes the acquired mail address, to the server apparatus 200.

Therefore, the beacon signal is received by the beacon reception unit 150, and thus the mail address of the printer 300 can be acquired and the processing request that includes the acquired mail address can be transmitted to the server apparatus 200. Therefore, it is easy to use the printer 300 via the server apparatus 200.

Furthermore, the terminal apparatus 100 is configured to include a touch panel that is configured with the display panel 175, the display panel 175, and the touch sensor 180, and detects the touch operation on the display panel 175.

The control unit 110 transmits the mail address, which is acquired from the beacon signal, to the server apparatus 200, and receives the printer information on the printer 300, which corresponds to the mail address, from the server apparatus 200. Furthermore, the control unit 110 causes the received printer information to be displayed on the display panel 175, and transmits the processing request, which includes the mail address of the printer 300 that corresponds to the printer information which is selected by an operation that results from the touch operation, to the server apparatus 200. Therefore, the request for the processing by the printer 300 that is selected by the user can be transmitted to the server apparatus 200.

Furthermore, according to the invention, the control unit obtains the proximity to the printer 300 is obtained based on the reception strength of the beacon signal that is received by the reception unit, and causes the obtained proximity to be displayed on the display unit in a state of being associated with the printer information.

According to the invention, the reception strength of the beacon signal and the printer information are displayed on the display unit in a state of being associated with each other. Therefore, the user can be requested to select the printer 300, which is caused to perform processing, based on the reception strength of the beacon signal or the printer information.

Furthermore, the control unit 110 causes the printer information to be displayed on the display panel 175 in order of decreasing the reception strength of the beacon signal.

Therefore, the printer 300 that is requested to perform the processing is easy to select.

Furthermore, the terminal apparatus 100 includes the speaker 135 or the display panel 175 as the reporting unit.

The control unit 110 causes the beacon reception unit 150 to receive the beacon signal that is dispatched from the printer 300 which corresponds to the printer information that is selected by the touch operation, and thus calculates the change in the reception strength of the received beacon signal. Based on the change in the reception strength, the control unit 110 makes a report using the speaker 135 or the display panel 175. Therefore, the direction of the selected printer 300 can be reported.

### Second Embodiment

A second embodiment of the invention is described. It is noted that configurations of the terminal apparatus 100, the server apparatus 200, and the printer 300 are the same as those in the first embodiment and thus descriptions of the configurations are omitted.

In the first embodiment, the printer information or information on the reception strength of the beacon signal is caused to be displayed on the display panel 175, and thus the user is requested to select the printer 300 that is caused to perform the processing. In the present embodiment, based on the beacon signal that is received by the beacon reception unit 150, the control unit 110 selects the printer 300 that is caused to perform the processing.

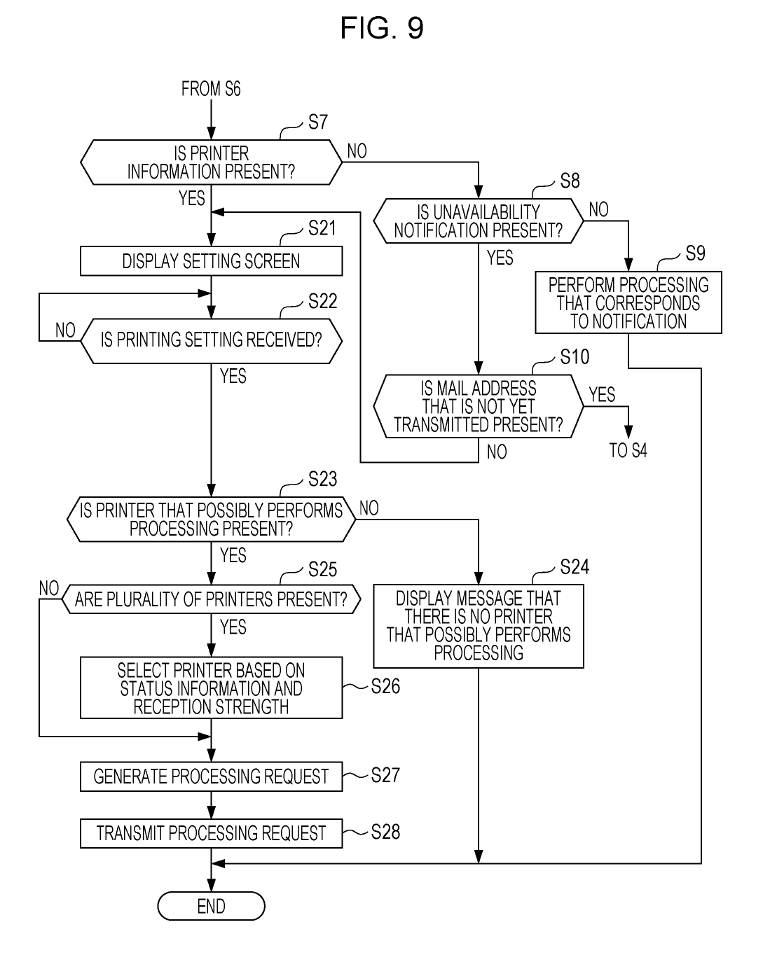

FIG. 9 is a flowchart illustrating operation of the terminal apparatus 100 according to the second embodiment. The terminal apparatus 100 according to the present embodiment is described with reference to a flowchart that is illustrated in FIG. 9. Furthermore, operation of the server apparatus 200 is the same as that in the first embodiment, which is described above, and thus a description thereof is omitted.

The flowchart that is FIG. 9, operations in Step S6 and subsequent steps that are illustrated in FIG. 6 are illustrated. Operations in Step S6 and the preceding steps are the same as those in the first embodiment, and thus descriptions thereof are omitted.

In the first embodiment, in a case where a mail address is not yet transmitted in Step S10 (NO in Step S10), in Step S11, it is determined whether or not the printer list is possibly displayed. In the present embodiment, proceeding to processing in Step S21 takes place without determining whether or not the printer list is possibly displayed.

In a case where the printer information is received from the server apparatus 200 (YES in Step S7), or in a case where a mail address that is not yet transmitted is not present (NO in Step S10), the control unit 110 causes a setting screen for the printing setting to be displayed on the display panel 175 (Step S21). On the setting screen, the number of copies for printing, color printing, both-sides printing, a printing size, printing-target data, and the like can be set. When the setting screen is displayed, the control unit 110 determines whether or not the printing setting is input (Step S22).

In a case where the printing setting is not input (NO in Step S22), the control unit 110 waits until the printing setting is input. Furthermore, when the printing setting is input (YES in Step S22), based on the printer information that is received from the server apparatus 200, the control unit 110 determines whether or not the printer 300 has a function of performing processing that corresponds to the printing setting is present (Step S23). For example, in a case where the color printing is set as a printing setting, based on the printer information, the control unit 110 determines whether or not the printer 300 that has a color printing function is present. Furthermore, in a case where the both-sides printing is set as a printing setting, based on the printer information, the control unit 110 determines whether or not the printer 300 that has a both-sides printing function is present. When it is determined that the printer 300 which has a function that corresponds to the printing setting is not present (NO in Step S23), the control unit 110 causes a message that the printer 300 which has the function that corresponds to the printing setting is not present, to be displayed on the display panel 175 (Step S24), and ends this processing flow.

Furthermore, in a case where the printer 300 that has the function which corresponds to the printing setting is present (YES in Step S23), the control unit 110 determines whether or not a plurality of printers 300 that have such a function are present (Step S25). When it is determined that one printer 300 that has the function is present (NO in Step S25), the control unit 110 proceeds to Step S27.

Furthermore, in a case where a plurality of printers 300 that have the function are present (YES in Step S25), based on the status information that is acquired from the beacon signal, or the reception strength of the beacon signal, the control unit 110 selects the printer 300 that is caused to perform the processing (Step S26). Specifically, the control unit 110 determines whether or not the printer 300 of which the status is “busy,” or “unavailable” is present among the printers 300 that have the function. In a case where the printer 300 that has the status of being busy or unavailable is present, the control unit 110 excludes such a printer 300 from a list of target printers 300 that are caused to perform the processing. Furthermore, in a case where, among the printers 300 that have the function, a plurality of printers 300 that have the status of being idle are present, based on the reception strengths of the beacon signals that are received from such printers 300, the control unit 110 selects the printer 300 that is positioned at a short distance from the terminal apparatus 100. The control unit 110 determines the selected printer 300 as the printer 300 that is caused to perform the processing.

When the printer 300 that is caused to perform the processing is determined, the control unit 110 generates a processing request that includes a mail address of the determined printer 300 and printing-target data (Step S27). The control unit 110 transmits the generated processing request to the server apparatus 200 (Step S28). Thereafter, the control unit 110 receives the beacon signal that is transmitted from the selected printer 300, and outputs a change in the reception strength of the beacon signal. Based on the calculated change in the reception strength of the beacon signal, the control unit 110 guides the user of the terminal apparatus 100 toward the printer 300 that makes the processing request.

As described above, in the second embodiment, in a case where the beacon signals that are dispatched from a plurality of printers 300 are received, based on the received beacon signal, the control unit 110 selects the printer 300 that is requested to perform the processing. Then, the control unit 110 transmits the processing request, which includes the identification information on the selected printer 300, to the server apparatus 200.

Therefore, the printer 300 that is requested to perform the processing can be selected based on the beacon signal.

Furthermore, the control unit 110 transmits the mail address that is acquired from the beacon signal, to the server apparatus 200, and receives the printer information indicating a processing capability of the printer 300, which corresponds to the mail address, from the server apparatus 200. Then, based on the received printer information, the control unit 110 selects the printer 300 that is requested to the processing, and transmits the processing request, which includes the identification information on the selected printer, to the server apparatus 200.

Therefore, the processing request can be made to the printer 300 that possibly performs the processing request.

Furthermore, the control unit 110 selects the beacon signal based on the reception strength of the beacon signal that is received by the beacon reception unit 150, and transmits the processing request, which includes the identification information that is acquired from the selected beacon signal, to the server apparatus 200.

Therefore, in a case where the printer 300 that has a great reception strength of the beacon signal is selected, the printer 300 that is positioned at a short distance from the terminal apparatus can be requested to perform the processing.

Furthermore, the control unit 110 acquires the status information indicating the processing situation of the printer 300 from the beacon signal that is received by the beacon reception unit 150, and based on the acquired status information, selects the printer 300 that is requested to perform the processing. Then, the control unit 110 transmits the processing request, which includes the identification information on the selected printer 300, to the server apparatus 200.

Therefore, the processing request can be set to be made to the printer 300 that is not requested to perform the processing, or the processing request can be set not to be made to the printer 300 that takes time to complete the processing.

The embodiments described above are suitable embodiments of the invention. However, the invention is not limited to the embodiments, and modifications to the embodiments can be made within the scope that does not depart the gist of the invention.

For example, in the embodiments described above, the terminal apparatus 100 is described as being configured to be connected to the network 20 through the base station 10, but the terminal apparatus 100 may be configured to be connected to the network 20 through the access point. The access point is an apparatus that possibly relays wireless communication by the terminal apparatus 100 in compliance with the known wireless LAN standards.

Furthermore, in the first embodiment and the second embodiment, which are described above, the mail address is used as the identification information on the printer 300, but the identification information may be information that possible specifies the printer 300 uniquely. For example, the UUID that is included in the beacon signal may be used as the identification information on the printer 300.

The beacon signal that is dispatched from the printer 300 is not limited to the beacon signal in compliance with BLE, and may be a beacon signal that is used for the access point on the wireless LAN, or an infrared ray beacon.

Furthermore, functional blocks of the terminal apparatus 100 that is illustrated in FIG. 2 and of the server apparatus 200 that is illustrated in FIG. 3 are schematic diagrams that illustrate results of categorizing principal details of functions that the terminal apparatus 100 has. A configuration of the terminal apparatus 100 or the server apparatus 200 can be divided into many more functional blocks according to the details of the processing. Furthermore, processing on a per-functional-block basis may be performed with one piece of hardware and may be performed with a plurality of pieces of hardware. Furthermore, processing on a per-functional-block basis may be performed with one program and may be performed with a plurality of programs.

Furthermore, the unit of processing in the flowcharts that are illustrated in FIGS. 6 and 9 results from the division that is performed according to the details of principal processing for easy understanding of processing by the control unit 110 of the terminal apparatus 100. The invention is not limited by a method or a name of the division in the unit of processing. The processing by the control unit 110 can also be performed in the many units of processing according to the details of the processing, and one unit of processing can be divided into the small units of processing in such a manner that more processing is performed. Furthermore, the order in which the processing in the flowchart described above is performed is not limited to the example that is illustrated. This is the same for the flowchart for the server apparatus 200, which is illustrated in FIG. 7.

Furthermore, in the embodiments described above, as an example, the case where the control program or the application program that is executed by the terminal apparatus 100 is stored in the ROM 112 or the storage unit 120 is described, but such a control program or such an application program does not necessarily need to be stored in the ROM 112 or the storage unit 120. For example, the control program or the application program may be configured to be stored in a portable storage medium, such as a computer-readable flexible disk (FD), a DVD, a DVD-RAM, and the portable storage medium may be a CD-ROM, a CD-R/RW, a magneto-optical disk, an IC card, or the like. Furthermore, the program may be stored in the server apparatus that is connected to the terminal apparatus 100 through a public communication line, the Internet, a LAN, a WAN, or the like, and the terminal apparatus 100 may read the program from the server apparatus for execution. Furthermore, the program may be downloaded from the server apparatus through a public communication line, the Internet, a LAN, a WAN, or the like for storage in a portable storage medium or a storage medium, and the terminal apparatus 100 may read the program from the portable storage or the storage medium for execution.

The entire disclosure of Japanese Patent Application No. 2017-147399, filed Jul. 31, 2017 is expressly incorporated by reference herein.

What is claimed is:

1. A terminal apparatus comprising:
a communication unit that communicates with a server apparatus which controls a device;
a reception unit that receives a beacon signal which is dispatched from the device and includes identification information on the device; and
a control unit that acquires the identification information on the device from the beacon signal which is received by the reception unit, and causes the communication unit to transmit a processing request, which is included in the acquired identification information, to the server apparatus.

2. The terminal apparatus according to claim 1,
wherein, in a case where the beacon signals that are dispatched from a plurality of the devices are received by the reception unit, the control unit selects the device that is requested to perform processing, based on the received beacon signal, and causes the processing request that includes the identification information on the selected device to be transmitted to the server apparatus.

3. The terminal apparatus according to claim 2,
wherein the control unit selects the beacon signal based on a reception strength of the beacon signal that is received by the reception unit, and causes the processing request, which includes the identification information that is acquired from the selected beacon signal, to be transmitted to the server apparatus.

4. The terminal apparatus according to claim 2,
wherein the control unit acquires status information indicating a processing situation of the device, from the beacon signal that is received by the reception unit, selects the device that is requested to perform the processing, based on the acquired status information, and causes the processing request including the identification information on the selected device, to be transmitted to the server apparatus.

5. The terminal apparatus according to claim 2,
wherein the control unit transmits the identification information, which is required from the beacon signal, to the server apparatus, receives device information indicating a processing capability of the device that corresponds to the identification information from the server apparatus, selects the device that is requested to perform the processing, based on the received device information, and causes the processing request, which includes the identification information on the selected device, to be transmitted to the server apparatus.

6. The terminal apparatus according to claim 2, further comprising:
a reporting unit,
wherein the control unit receives the beacon signal that is dispatched from the selected device, and causes the reporting unit to make a report based on a change in a reception strength of the received beacon signal.

7. The terminal apparatus according to claim 1, further comprising:
a display unit; and
an operation unit,
wherein the control unit transmits the identification information, which is received from the beacon signal, to the server apparatus, receives device information on the device that corresponds to the identification information, from the server apparatus, causes the received device information to be displayed on the display unit, and causes the processing request, which includes the identification information on the device that corresponds to the device information that is selected by an operation that is performed in the operation unit, to be transmitted to the server apparatus.

8. The terminal apparatus according to claim 7,
wherein the control unit obtains proximity to the device based on a reception strength of the beacon signal that is received by the reception unit, and causes the obtained proximity to be displayed on the display unit in a state of being associated with the device information.

9. The terminal apparatus according to claim 7,
wherein the control unit causes the device information to be displayed in order of decreasing a reception strength of the beacon signal.

10. The terminal apparatus according to claim 7, further comprising:
a reporting unit; and
wherein the control unit receives the beacon signal that is dispatched from the device which corresponds to device information that is selected by an operation that is performed in the operation unit, and causes the reporting unit to make a report based on a change in the reception strength of the received beacon signal.

11. The terminal apparatus according to claim 1,
wherein the identification information is a mail address that is assigned to the device.

12. The terminal apparatus according to claim 1,
wherein the server apparatus causes the device, which corresponds to the identification information that is included in the received processing request, to perform processing that corresponds to the processing request.

13. A computer-readable recording medium on which a program, which is caused to be executed by a computer that is built into a terminal apparatus which includes a communication unit that communicates with a server apparatus that controls a device and a reception unit that receives a beacon signal which is dispatched from the device, is stored, the program causing the computer to execute:
a procedure for acquiring identification information on the device, which is included in the beacon signal that is received by the reception unit; and
a procedure for causing the communication unit to transmit a processing request, which is included in the acquired identification information, to the server apparatus.

14. A method of controlling a terminal apparatus that includes a communication unit which communicates with a server apparatus that controls a device and a reception unit which receives a beacon signal which is dispatched from the device, the method comprising:
acquiring identification information on the device, which is included the beacon signal that is received by the reception unit; and
causing the communication unit to transmit a processing request, which is included in the acquired identification information, to the server apparatus.
